(19) United States
(12) Patent Application Publication
(10) Pub. No.: US 2024/0250327 A1
(43) Pub. Date: Jul. 25, 2024

(54) METHODS OF PURIFYING AND PRECIPITATING MATERIALS FROM BATTERIES FOR RECYCLING AND MANUFACTURING PROCESSES

(71) Applicant: Redwood Materials, Inc., Carson City, NV (US)

(72) Inventors: Paul Voigt, Reno, CA (US); Jackson Switzer, Incline Village, NV (US); Mary Lou Lindstrom, Reno, NV (US)

(21) Appl. No.: 18/418,033

(22) Filed: Jan. 19, 2024

Related U.S. Application Data
(60) Provisional application No. 63/440,281, filed on Jan. 20, 2023.

(51) Int. Cl. H01M 10/54; C22B 3/00; C22B 7/00; C22B 26/12

(52) U.S. Cl. CPC H01M 10/54; C22B 7/007; C22B 23/0461; C22B 26/12

(57) ABSTRACT

The present disclosure relates to systems and methods for recovering one or more nickel containing products and producing a lithium sulfate solution from battery manufacturing scrap materials with improved byproducts and minimal waste streams. In particular, in one or more embodiments, the disclosed methods can comprise leaching, in an acidic solution, battery manufacturing scrap materials to produce solution containing metals. Additionally, the methods can process the solution containing metals to recover one or more nickel containing products and produce a lithium sulfate solution. Further, the methods can evaporate the lithium sulfate solution to produce lithium sulfate (Li₂SO₄).

### CROSS-REFERENCE TO RELATED APPLICATIONS

The present application claims the benefit of, and priority to, U.S. Provisional Patent Application No. 63/440,281, filed on Jan. 20, 2023, and entitled Purification and Precipitation Methods for Battery Recycling and Manufacturing Processes. The aforementioned patent application is hereby incorporated by reference in its entirety.

### BACKGROUND

Due to the development of the world economy and urban transportation, oil shortages and environmental pollution is occurring to greater and greater extents. In response, many developed countries in the world are competing to develop green energy technologies. Among them, the power supply field represented by electric vehicle applications is fastest growing. Indeed, electric vehicles are the key to replacing fuel vehicles and their associated negative effects.

Due to the low energy storage, heavy weight, short life, and hazards of traditional chemical batteries, battery production has become a bottleneck in the industrialization of electric vehicles. The utilization rate of lithium batteries in electric vehicles is increasing significantly. Because lithium-ion batteries are likely to become a future mainstream power supply route for electric vehicles, there is ample room for development and growth in the lithium battery industry.

With the wide application of lithium-ion batteries as the power supply for electric vehicles, how to recycle used lithium-ion batteries and recycle resources has become a common concern in society. For resource recycling and sustainable development of the industry, the valuable battery metals should be recycled.

Recent years have seen significant interest in improving battery recycling systems. For example, conventional systems include the production of expensive and minimally useful byproducts. To illustrate, conventional systems often produce byproducts such as sodium sulfate which can be problematic in recovering metals from recycled batteries. Further, conventional systems often produce waste streams that must be heavily treated before being discharged or before components thereof can be reused.

These along with additional problems and issues exist with regard to conventional battery recycling systems.

### SUMMARY

Embodiments of the present disclosure provide benefits and/or solve one or more of the foregoing or other problems in the art with methods for recovering battery materials from battery manufacturing scrap materials with improved byproducts and minimal waste streams. In particular, the methods can include recovering valuable metals from battery manufacturing scrap and generating products important to battery manufacturing and recycling through a variety of processes including mechanical separation, acid leaching, precipitation, electrolysis, oxidation, precipitation, etc.

For example, the methods can include recovering metals such as aluminum, iron, and copper from battery manufacturing scrap materials through a mechanical separation. Furthermore, as part of a lithium recovery process, one or more embodiments include producing a stream including lithium and other metals via one or more acid leaching processes Furthermore, the methods can include performing differing levels of processing to recover nickel containing products in different forms from the metals containing stream. For example, one or more embodiments include recovering a nickel containing product in the form of a hydro metal concentrate (e.g., a combined product containing high nickel concentrate, mixed hydroxide precipitate (MHP), and gypsum). One or more alternative embodiments include recovering a nickel containing product in the form of a high nickel concentrate and a separate combined MHP and gypsum product. Additionally, the MHP and gypsum can be separated in one or more embodiments. Still further embodiments include producing a mixed metal sulfate (MMS) through evaporation and crystallization. Furthermore, the methods can include purifying MMS to make a suitable feed to pCAM without further purification. Additionally, or alternatively, the systems and methods can include precipitating additional base metals from the MMS through the addition of calcium based products such as lime, thereby separating these metals from lithium without producing a sodium sulfate byproduct. Furthermore, various embodiments include recovering lithium in addition to the nickel containing products with improved byproducts and minimal waste streams.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a process for recovering Ni containing products and lithium sulfate (Li₂SO₄) from battery manufacturing scrap materials in accordance with one or more embodiments.

FIG. 2 illustrates a process for recovering a hydro-metal concentrate and Li₂SO₄ from battery manufacturing scrap materials in accordance with one or more embodiments.

FIG. 3 illustrates a process for recovering a high nickel concentrate and i₂SO₄ from battery manufacturing scrap materials in accordance with one or more embodiments.

FIG. 4 illustrates a process for recovering an MMS and Li₂SO₄ from battery manufacturing scrap materials in accordance with one or more embodiments.

FIG. 5 illustrates an example series of acts for recovering battery materials from battery manufacturing scrap materials with improved byproducts and minimal waste streams in accordance with one or more embodiments.

FIG. 6 illustrates another example series of acts for recovering battery materials from battery manufacturing scrap materials with improved byproducts and minimal waste streams in accordance with one or more embodiments.

FIG. 7 illustrates yet another example series of acts for recovering battery materials from battery manufacturing scrap materials with improved byproducts and minimal waste streams in accordance with one or more embodiments.

### DETAILED DESCRIPTION

This disclosure describes one or more embodiments of methods that recover battery metals, including lithium, from battery manufacturing scrap materials with improved byproducts and minimal waste streams and converts the lithium to battery grade lithium hydroxide (LiOH) or lithium sulfate monohydrate. More specifically, the methods can include recovering valuable metals from battery manufacturing scrap materials and generating products important to battery manufacturing and recycling through a variety of processes including mechanical separation, acid leaching, precipitation, electrolysis, oxidation, precipitation, etc. One or more embodiments include one of two leaching processes. Specifically, in one or more embodiments, a first leaching process includes a sulfuric acid leach that is performed to selectively recover the lithium over nickel and cobalt into solution. The second leaching process includes a sulfuric acid leach that is performed with the addition of peroxide to maximize the recovery of lithium, nickel, and cobalt into solution. In the first leaching process, minimal processing, complexity, and cost is required to recover lithium from the feed rendering the nickel and cobalt in a desirable form for further refinement. In the second leaching process, more intensive processing is applied in the leaching stage through the addition of peroxide or other reductant to leach nearly all of the nickel, cobalt, and lithium into solution, where the majority of that nickel and cobalt is recovered in the form of a metal sulfate salt that can be easily integrated with a pCAM operation following purification of the metal sulfate salt. In both cases the lithium is separated from the nickel and cobalt for recovery as lithium sulfate and optionally converted to lithium hydroxide.

More particularly, one or more embodiments include recovering metals such as aluminum (Al), iron (Fe), and copper (Cu) from cathode and anode electrode powders (e.g., cathode active material and graphite) through a mechanical separation process. Furthermore, as part of the lithium recovery process, one or more embodiments include producing a stream including lithium and other metals via one or more acid leaching processes. One or more embodiments described herein address the challenge of separating the remaining metals in solution from the lithium so the lithium can be recovered and optionally converted to LiOH. Furthermore, one or more embodiments described herein separate the remaining metals in solution from the lithium without generating sodium sulfate byproduct, which is expensive to manage since sodium sulfate must be crystalized in two stages in order to separate it from the lithium and then the final product may not be commercial grade. Indeed, one or more embodiments described herein separate the remaining metals in solution from the lithium without performing precipitation with a sodium-based alkali, such as sodium hydroxide, to avoid producing sodium sulfate, as done by conventional processes.

One or more implementations recover nickel containing products in one or more different forms, depending upon a desired final use of recovered materials or desired processing efficiency/steps. Embodiments of various implementations include performing differing levels of processing to recover nickel containing products in different forms. For example, one or more embodiments include recovering a nickel containing product from battery manufacturing scrap materials in the form of a hydro metal concentrate (e.g., a combined product containing high nickel concentrate, mixed hydroxide precipitate (MHP), and gypsum). For example, the methods include acid leaching (e.g., without peroxide) battery manufacturing scrap materials to selectively leach lithium at high efficiency while leaching Ni at a lower efficiency. The leaching process produces a stream containing metals. Further, in some embodiments, the methods include processing the stream containing metals to recover a hydro metal concentrate. Specifically, in one or more implementations, the methods involve precipitating metals from the stream by adding a calcium based product (e.g., lime) and filtering the stream to recover the hydro metal concentrate. Producing a hydro metal concentrate may require fewer processing steps, resulting in a more efficient process, but result in a relatively raw and unrefined products while still leaving lithium in solution for recovery in subsequent processes.

One or more alternative embodiments include recovering a nickel containing product from the stream in the form of a high nickel concentrate and a separate but combined MHP and gypsum product. Specifically, such embodiments include filtering a high nickel concentrate from the stream containing metals resulting from acid-leaching (e.g., without peroxide) mechanically separated battery manufacturing materials. For example, the methods can include sending the stream containing metals to a filter tank and then utilizing a filter aid, e.g., diatomaceous earth (DE) to filter the stream. In one or more embodiments, filtering the stream containing metals with the filter aid renders a clear filtrate and a competent filter cake (i.e., the high nickel concentrate) for transportation. Further, in one or more embodiments, the methods include separating lithium in the resulting filtrate from other metals (e.g., Ni, Co, and Al) by precipitating the metals with a calcium based product (e.g., hydrated lime) using similar methods to those described above, which results in the combined MHP and gypsum product. In such implementations, the gypsum can further be separated from the MHP or left in the combined MHP and gypsum product. Recovering high nickel concentrate and a separate but combined MHP and gypsum product may require more processing steps than producing a hydro metal concentrate but result in more refined products.

Still further embodiments include producing a mixed metal sulfate (MMS) from the stream containing metals through evaporation and crystallization. Furthermore, the methods can include purifying MMS and utilizing it as a suitable feed to pCAM without further purification from the MMS purification. Additionally, or alternatively, the systems and methods can include precipitating additional base metals from the MMS through the addition of calcium based products such as lime, thereby separating these metals from lithium without producing a sodium sulfate byproduct. In one or more embodiments, the methods can produce an MMS of nickel (Ni), Manganese (Mn), and cobalt (Co). The methods can produce the MMS by evaporation and optionally crystallization of the metals containing filtrate resulting from acid leach filtration of the stream containing metals. This MMS producing process can recover Ni and Co without incorporating lithium by exploiting the relative differences in solubilities and concentrations of ions in solution after leaching. In one or more embodiments when the unpurified MMS is not a suitable feed to pCAM without further purification, the methods can include further purifying the MMS. For instance, the methods can purify the MMS by oxidation and precipitation at an elevated pH using a base, such as caustic, and a sulfide, such as sodium sulfide. This process can remove impurities such as Al, Cu, and Fe, for example. Alternatively, the methods can employ ion exchange (IX) or solvent extraction (SX) to remove impurities from the MMS. The methods can feed the purified, MMS to precursor cathode active material (pCAM) processing without further purification. Further, different metals can be mixed with the MMS to adjust the metal ratios to suit the desired pCAM product. Additionally, the methods can include purifying the MMS separately from the overall recycling process by removing the unpurified MMS for later redissolution and purification in a separate process.

As mentioned above, methods of one or more implementations can separate lithium from other base metals in solution by precipitation with hydrated lime. In some embodiments, this separation by precipitation can receive as an input a centrate remaining after producing the MMS. The methods can precipitate a mixed hydroxide precipitate (MHP) incorporating the metals (e.g., Ni, Co, and Al) by adding the hydrated lime to the input, leaving the lithium in solution. In addition to the MHP, this process produces gypsum. In one or more embodiments, the methods include removing the MHP and gypsum from a lithium containing solution. The MHP and gypsum can then be sold as a combined product or the gypsum and MHP can be separated for sale as separate products or the MPH can be recycled back to the leach. Producing MMS can require more processing but result in more refined products.

Furthermore, in some implementations, the methods can include recovering the lithium by evaporating a lithium sulfate solution to produce Li₂SO₄ and converting the Li₂SO₄ to battery grade LiOH. The methods can include evaporating the lithium sulfate solution generated from precipitating the base metals with hydrated lime to isolate or allow recovery of the Li₂SO₄. The methods can further include converting the Li₂SO₄ (whether in liquid form or solid form (e.g., Li₂SO₄*H₂O) to battery grade LiOH or Li₂CO₃ by electrolysis and/or conventional lithium conversion techniques. Additionally, the methods can include recycling H₂SO₄ produced as a byproduct of the electrolysis of Li₂SO₄ to the acid leaching of the mechanically separated battery materials.

The methods provide a variety of technical advantages relative to conventional systems. For example, by avoiding sequential solvent extraction and the formation of sodium sulfate byproducts, the methods minimize capital and operating costs, and lower the environmental impact relative to conventional systems. Specifically, the disclosed methods can avoid formation of sodium sulfate byproducts by separating base metals from lithium by precipitation with hydrated lime to produce the MHP as well as by purifying the MMS separately from the overall recycling process. In contrast, some conventional methods base metals from lithium by sequential solvent extraction and/or use solvent extraction to separate Ni from Co as discrete salts. Alternatively, conventional methods can also use recovery techniques such as precipitation with sodium based reagents (e.g., sodium carbonate, sodium hydroxide) to separate base metals from lithium. Such techniques result in the formation of sodium sulfate byproducts which can be expensive to manage. For example, the sodium sulfate must be separated from lithium and then the sodium sulfate and the lithium must be recovered in separate stages. Further, the use of sodium based reagents also has a significant carbon dioxide footprint. One or more implementations avoid costs associated with the foregoing conventional methods by forming MMS as described herein.

Moreover, by producing useful byproducts and less problematic waste streams that the methods can recycle back into the processes, the methods further minimize capital costs, create new income, and reduce environmental impacts. For instance, the methods can include recycling Li containing streams, such as wash solution from filtering the slurry containing metals into the hydrometallurgical circuit to reuse the solution and recover additional lithium. Additionally, the methods produce useful byproducts such as MHP and gypsum which can be sold as a combined product or which the methods can use in the process of filtering the solution containing metals to produce the hydro metal concentrate. In one or more embodiments, by using these byproducts in the filtering process, the methods can eliminate the need for the use of a filter aid, such as DE, thereby reducing costs and minimizing the inputs. In addition, the methods can utilize H₂SO₄ produced from converting the Li₂SO₄ via electrolysis as a recycled input to the reductive acid leaching of mechanically separated battery manufacturing scrap materials, thereby further minimizing the inputs into the processes.

Furthermore, by minimizing the inputs and accepting waste streams from battery manufacturing processes, the methods can further minimize costs and minimize environmental impacts. For example, in some implementations, the methods can avoid the use of peroxide which results in a significant reduction of operating cost. Also, using a calcium based product to separate lithium from base metals minimizes costs (e.g., because calcium based products like hydrated lime and calcium carbonate are low-cost reagents) and minimizes environmental impacts in contrast to the use of sodium based reagents as in conventional systems. Additionally, the methods can incorporate the acid stream from electrolysis processing of sodium sulfate arising from pCAM production during battery manufacturing into the recycling process. Doing so offsets most of the sulfuric acid (H₂SO₄) input, thereby significantly improving the economics and reducing the carbon dioxide footprint of the recycling process as well as regenerating caustic for the pCAM process.

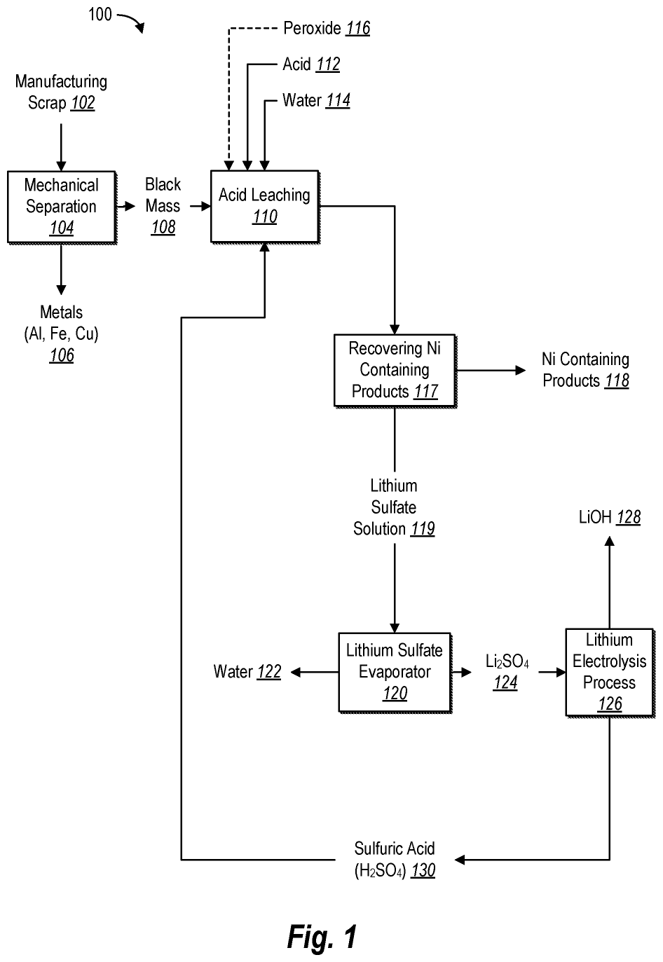

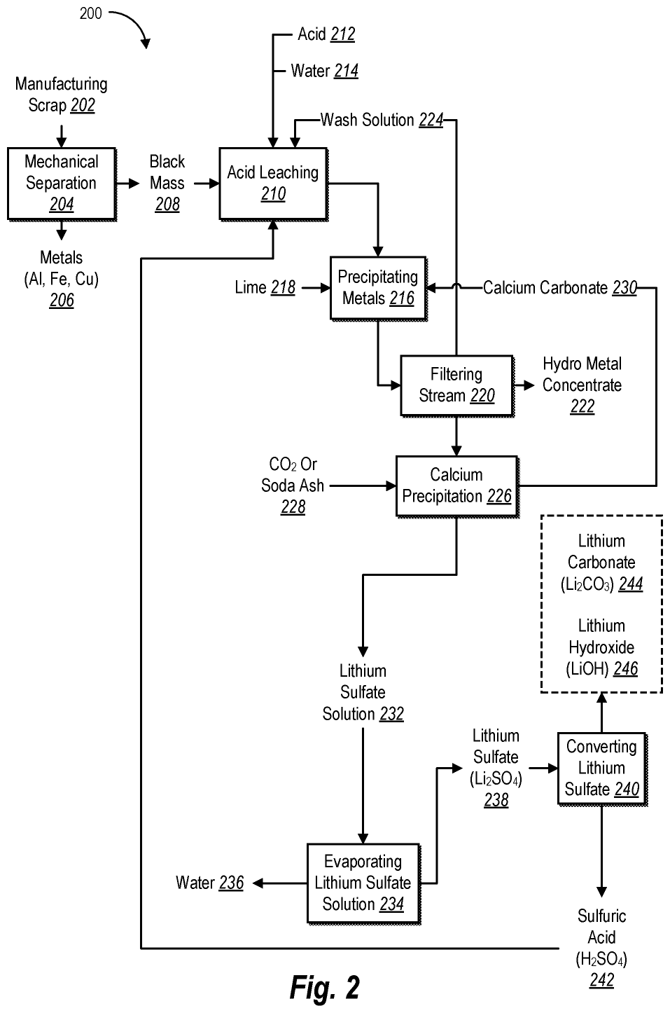

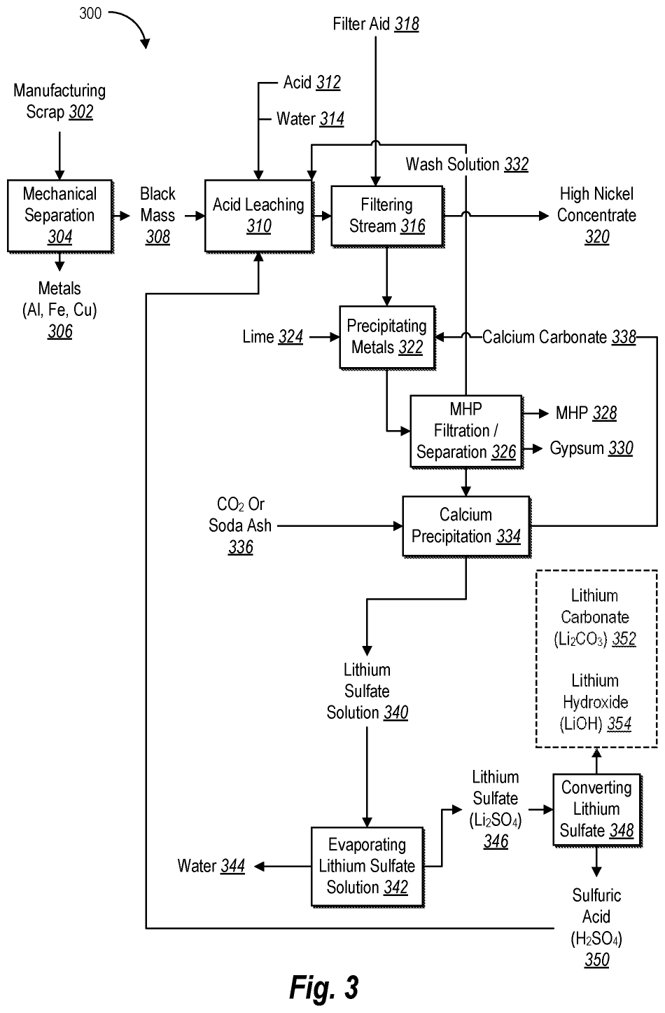

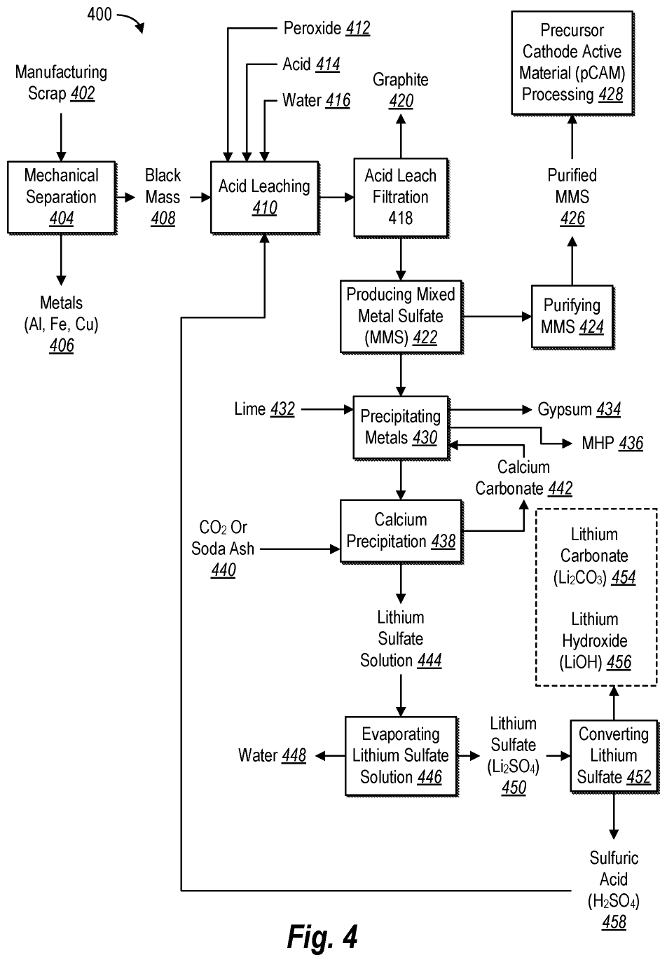

As mentioned above, one or more implementations recover Ni containing products in one or more different forms and lithium from battery manufacturing scrap materials. More details of such methods will now be described with reference to the Figures. Specifically, FIG. 1 illustrates and example general process flow of recovering Ni containing products and lithium. FIG. 2 illustrates an example process flow of recovering lithium and a Ni containing product in the form of a hydro metal concentrate. FIG. 3 illustrates an example process flow of recovering lithium and a Ni containing product in the form of a high nickel concentrate and a combined MHP and gypsum product. FIG. 4 illustrates an example process flow of recovering lithium and a Ni containing product in the form of MMS.

FIG. 1 illustrates a process 100 of recovering Ni containing products and lithium from battery manufacturing scrap materials 102 in accordance with one or more embodiments. Specifically, the process 100 can include processing manufacturing materials 102 via mechanical separation 104 resulting in a black mass (BM) fraction 108. For example, in one or more implementations the battery manufacturing scrap materials comprises manufacturing scraps (e.g., non-live or live production scrap). In any event, the process 100 starts with processing manufacturing materials 102 via mechanical separation 104. The mechanical separation 104 can utilize size sorting, size reduction, or screening to separate various scrap materials. For example, the mechanical separation 104 can separate metals 122 (e.g., Al, Fe, Cu) such as cathode active materials from aluminum foil held on with binder. Further, the mechanical separation 104 can separate graphite from copper foil, among other materials. Additionally, the methods optionally can include reincorporating the separated aluminum foil and copper foil back into battery recycling processes. Moreover, the mechanical separation 104 can isolate separator material and can incorporate the separator material (e.g., polyolefin, ceramics, polymer/ceramic blends) into battery manufacturing processes. Alternatively, the separator material can be sold to third parties. In one or more embodiments, the mechanical separation 104 process can result in a black mass (BM) fraction 108 containing lithium and various metals, which are then utilized in additional processing steps in a hydrometallurgical circuit.

Further, in one or more implementations, the process 100 includes leaching 110 the BM 108 in a hydrometallurgical circuit. For example, the process 100 includes acid leaching 110 of the resulting BM 108. Indeed, the methods can include tailoring the acid leaching 110 within an oxidation-reduction potential (ORP) range to optimize the selectivity and/or extraction rate of the process for specific metals. For instance, the methods can utilize reductive acid leaching that includes acid 112 (e.g., sulfuric acid (H₂SO₄)), peroxide 116, and water 114. In other embodiments, the methods can utilize oxidative acid leaching that includes acid 112 (e.g., sulfuric acid (H₂SO₄)) and water 114 but excludes peroxide 116. In some embodiments, the acid leaching can utilize other chemical compositions including metals in different oxidation states from other recycling processes. For example, when the black mass is generated from thermal processing.

In one or more embodiments, the acid leaching 110 liberates nearly all the metals into solution leaving behind a graphite material. For example, the stream containing metals can comprise Ni, Co, Al, Li, and Cu as sulfates (i.e., a metal sulfates solution) and graphite. In some embodiments, the acid leaching 110 can liberate nearly all the lithium into solution. For example, the acid leaching 110 can liberate more than 95%, 90%, 85%, 80%, 75%, 70%, 65%, 55%, or more than 50% of the lithium into solution. Further, in one or more implementations, the acid leaching 110 can liberate between 30 to 50%, between 20 to 60%, or between 10 to 98% of the Ni, Co, and Al. In some embodiments, the process 100 can further include filtering the stream containing metals resulting from the acid leaching 110 for subsequent processes such as the process 117 of recovering Ni containing products and recovering Li₂SO₄ 124 via evaporation and electrolysis or other conventional lithium conversion techniques.

Moreover, in some implementations, the process 100 includes the process 117 of recovering Ni containing products 118 from the stream containing metals resulting from the acid leaching 110. For example, the process 100 can recover a Ni containing product 118 in the form of a hydro metal concentrate as described in more detail in relation to FIG. 2, a high nickel concentrate and an MHP/Gypsum product as described in more detail in relation to FIG. 3, or MMS and MHP/Gypsum as described in more detail in relation to FIG. 4. Indeed, the process 100 can include recovering Ni containing products 118 utilizing a variety of methods such as precipitating metals from the stream resulting from acid leaching 110, filtering the stream, and/or using an evaporator and/or crystallizer to produce the MMS as discussed in further detail with respect to FIGS. 2-4. In any event, the process 117 of recovering Ni containing products from the stream resulting from the acid leaching produces one or more Ni containing products 118 and a lithium sulfate solution 119.

As noted above, in one or more implementations, the methods can include recovering lithium from the lithium sulfate solution 119. For example, in one or more implementations, the methods include processing the lithium sulfate solution in a lithium sulfate evaporator 120 to generate Li₂SO₄ 124 and water 122, which the methods can recycle back into the battery recycling process. The methods can further hold the Li₂SO₄ 124 as a solution or a solid (e.g., lithium sulfate monohydrate (LSM)) for later redissolution.

In one or more embodiments, the process 100 can further include converting the Li₂SO₄ 124 by a lithium electrolysis process 126. In one or more embodiments, the process 100 can include converting the Li₂SO₄ 124 by electrolysis to Li₂CO₃ (indirectly) or battery grade LiOH 128 (directly). The electrolysis can also generate dilute acid (e.g., dilute H₂SO₄ 130) as a byproduct. In one or more embodiments, as mentioned previously, the process 100 can include recycling H₂SO₄ 130, a byproduct of the lithium electrolysis process 126, to the acid leaching 110. Further, the process 100 can include maintaining a water balance such that the process 100 recirculates the H₂SO₄ 130 back into the battery recycling process (e.g., back to acid leaching 110) or into other manufacturing processes. In one or more additional embodiments, other conventional lithium recovery processes are used.

As mentioned above, one or more embodiments include recovering a nickel containing product in the form of a hydro metal concentrate and lithium from battery manufacturing scrap materials. For example, FIG. 2 illustrates a process 200 for recovering lithium and a hydro metal concentrate 222 from the metals containing stream resulting from the acid leaching 210 in accordance with one or more embodiments. Specifically, the process 200 can include processing manufacturing materials 202 via mechanical separation 204 resulting in a BM fraction 208 (or BM 208) similar to the mechanical separation 104 of process 100. Indeed, the mechanical separation 204 can separate similar metals 206 (e.g., Al, Fe, Cu) and various other battery materials in a similar manner and for similar purposes as described above with respect to the mechanical separation 104. Also, in one or more embodiments, the mechanical separation 204 results in the BM 208 of similar composition/s to the BM 108 as described.

Further, in one or more implementations, the process 200 includes acid leaching 210 the BM 208. For example, the methods utilize acid 212 and water 214 for the acid leaching 210. In one or more embodiments, the methods exclude peroxide from the acid leaching 210 to tailor the process to be selective for lithium. In these or other embodiments, the methods target the lithium in the BM 208 by tailoring the conditions of the acid leaching 210 to be within the oxidative portion of the ORP. When leaching without peroxide, the acid leaching 210 can operate with an ORP between approximately 800 and approximately 1200 and between approximately pH 1.0 and approximately 4.0. In some implementations, the methods also utilize the recycled H₂SO₄ 242 in the acid leaching 210 as discussed in further detail below. Further, in some embodiments, the methods can utilize recycled wash solution 224 resulting from a subsequent filtering process as discussed in further detail below.

In one or more implementations, the acid leaching 210 is performed with sulfuric acid 212 and water 214, which liberates nearly all of the lithium into solution but only around 30 to 50% of the Ni, Co, and Al. Indeed, the acid leaching 210 produces a solution containing metals (e.g., Ni, Co, Al, Li, and Cu as sulfates).

Moreover, in one or more embodiments, the process 200 includes processing the metals containing slurry resulting from the acid leaching 210 to recover a hydro metal concentrate 222 (e.g., a combined product containing high nickel concentrate, mixed hydroxide precipitate (MHP), and gypsum). Specifically, in one or more embodiments, a process 216 of precipitating metals is performed with lime 218. Specifically, the methods can include separating the base metals in the metal containing stream from lithium by adding hydrated lime 218 (i.e., Ca(OH)₂) to precipitate the base metals out of solution. In these or other embodiments, the hydrated lime 218 raises the pH producing MHP and gypsum. The elevated pH allows the MHP to form without incorporating lithium. In some embodiments, the method can include using limestone (CaCO₃) to get the solution to a pH of approximately 6.0 and then treating the feed solution with the hydrated lime 218. Further, the addition of hydrated lime 218 forms gypsum which usually contaminates the resulting base metal precipitate (e.g., the MHP).

In this implementation, the method 200 further include the process 220 of filtering the metal slurry. In particular, the process 220 of filtering the metal slurry does not require a filter aid in contrast to other methods discussed below with respect to FIG. 3. Indeed, filtering the metal slurry recovers a hydro metal concentrate 222, a valuable combined product including a high nickel concentrate, MHP, and gypsum. Further, the hydro metal concentrate 222 is competent and amenable to transportation (e.g., bulk transportation) even without a filter aid. Moreover, in some implementations, the process 220 of filtering the metal slurry utilizes a wash solution 224 which can displace a portion of the lithium in the solution phase. In these or other embodiments, the methods include recycling the wash solution 224 to the acid leaching 210 to recover the lithium. By incorporating the process 216 of precipitating metals and the process 220 of filtering the metal slurry, the process 200 achieves separation of base metals from the lithium in solution while avoiding various drawbacks of conventional methods as described above.

Additionally, as shown, the process 200 includes calcium precipitation 226 of the lithium containing solution remaining after recovery of the hydro metal concentrate 222. Specifically, in some embodiments, the calcium precipitation 226 includes the use of soda ash or carbon dioxide (CO₂) 228. Further, the calcium precipitation 226 can include continuously drawing the soda ash and/or carbon dioxide to lower the calcium concentration in the lithium containing solution.

Adding soda ash or carbon dioxide may minimize or prevent soluble calcium formation from carrying through to a lithium evaporator in subsequent processes. By minimizing or preventing soluble calcium carry through to subsequent processes, the methods realize advantages such as preventing fouling and contamination in subsequent processes as well as preventing negative impacts on product quality.

The calcium precipitation can result in a lithium sulfate solution 232 and a calcium carbonate (CaCO₃) 230 byproduct. The calcium precipitation stage can further include a filter to isolate the CaCO₃. In one or more embodiments, the methods recycle the CaCO₃ 230 to the process 216 of precipitating metals. The lithium sulfate solution 232 can be further processed to recover lithium containing products such as Li₂CO₃ and LiOH.

As just mentioned, in one or more implementations, the process 200 includes recovering lithium from the lithium sulfate solution 232. For example, the methods can include a process 234 of evaporating the lithium sulfate solution to generate Li₂SO₄ 238 and a process 240 of converting the Li₂SO₄ 238 to Li₂CO₃ 244 and LiOH 246 via a lithium electrolysis process (also referred to simply as electrolysis). In one or more embodiments, the process 234 of evaporating the lithium sulfate solution produces water 236 and Li₂SO₄ 238. In these or other embodiments, the methods can recycle the water 236 back into the battery recycling process while holding the Li₂SO₄ 238 as a solution or a solid crystal for later redissolution. In some implementations, the process 240 of converting the lithium sulfate can include converting the Li₂SO₄ 238 to battery grade LiOH 246 using a combination of electrolysis and precipitation. Further, in some implementations, the process 240 of converting the lithium sulfate utilizes CO₂ precipitation of the LiOH 246 to generate the Li₂CO₃ 244. This recovery and conversion avoids the formation of sodium sulfate, which has the challenges discussed herein, typical of conventional systems.

As mentioned previously, in some implementations, the process 200 further includes recycling the H₂SO₄ 242, a byproduct of the process 240 of converting the lithium sulfate, to the acid leaching 210. In one or more embodiments, the recycling of H₂SO₄ 242 is similar to the recycling of H₂SO₄ 130 described above with respect to the lithium electrolysis process 126. For example, the process 240 of converting the lithium sulfate generates dilute H₂SO₄ 242 as a byproduct, which the methods can recycle to the acid leaching 210 to offset the acid 212 input or use in other manufacturing processes. Further, in one or more implementations, the process 200 includes maintaining a water balance of the hydrometallurgical circuit such that this recycling of the dilute H₂SO₄ 242 is possible.

As mentioned above, one or more embodiments include recovering a nickel containing product in the form of a high nickel concentrate and lithium from battery manufacturing scrap materials. For example, FIG. 3 illustrates a process 300 for recovering a high nickel concentrate 320 from the metals containing stream resulting from the acid leaching 310 in accordance with one or more embodiments. Specifically, the process 300 can include processing manufacturing materials 302 via mechanical separation 304 resulting in a BM fraction 308 (or BM 308). In one or more embodiments, the mechanical separation 304 is similar to the mechanical separation 104 as described above. Indeed, the mechanical separation 304 can separate similar metals 306 (e.g., Al, Fe, Cu) and various other battery materials in a similar manner and for similar purposes as described above with respect to the mechanical separation 104. Also, in one or more embodiments, the mechanical separation 304 results in the BM 308 of similar composition/s to the BM 108 as described.

Further, in one or more embodiments, the process 300 includes acid leaching 310 the BM 308. In some implementations, the acid leaching 310 can be substantially similar in process and components as described above with respect to the acid leaching 210. For example, the acid leaching 310 can include incorporating acid 312 and water 314, as well as wash solution 332 as described in further detail with respect to the MHP filtration/separation 326. Additionally, the acid leaching 310 generates a metal containing stream similar to that described above with respect to the acid leaching 210. Specifically, as shown, the acid leaching 310 process can be tailored to liberate lithium into solution. For example, when leaching without peroxide, the acid leaching 210 can operate with an ORP between 800-1200 and pH 1.0 to 4.0.

As noted above, in some implementations, the process 300 includes processing the metals containing stream resulting from the acid leaching 310 to recover the high nickel concentrate 320. Specifically, in one or more embodiments, processing the metals containing stream resulting from the acid leaching 310 can include a process 316 of filtering the metal stream, a process 322 of precipitating metals, and a process 326 of MHP filtration/separation.

As just mentioned, the methods can include filtering the metals containing stream after the acid leaching 310 as shown in FIG. 3. Specifically, in some embodiments, the process 316 of filtering the metal stream utilizes a filter aid 318 to produce the high nickel concentrate 320. For example, the methods can include utilizing a filter aid 318 when sending the metal slurry produced from the acid leaching 310 to the filter tank, as shown in FIG. 3. Filtering the metal stream using the filter aid 318 renders a clear filtrate and a competent filter cake for transportation. In some implementations, the filter aid 318 can include commonly used filter aids such as diatomaceous earth (DE). Further, in some embodiments, the filter aid 318 can be used at a dilution of between 5 and 25% to render a clear filtrate and for optimal filtration performance (e.g., filtration rate, solution purity, and washing efficiency). In one or more implementations, the filter aid 318 dilution can be from 2-35% or from 1-50%. Alternatively, in some embodiments, filtering the metal stream can include the use of chemical additives such as filter flocculants in place of the filter aid 318.

As mentioned, in some implementations, processing the metals containing stream resulting from the acid leaching 310 further includes precipitating metals from the filtered metal solution. For example, in these or other embodiments, a filtered metal solution remains after recovering the high nickel concentrate 320. This filtered metal solution contains base and other metals (e.g., Co and Al), which the method 300 separates from lithium by a process 322 of precipitating metals using lime 324 (e.g., hydrated lime). This process 322 of precipitating metals is substantially similar to the process 216 of precipitating metals described above, except that the process 316 of filtering the metal solution recovers the majority of the Ni from the solution prior to the process 322 of precipitating metals. Indeed, in these or other embodiments, the process 322 of precipitating metals with hydrated lime 324 forms MHP 328 and gypsum 330 without incorporating lithium. Thus, the process 322 of precipitating metals results in a lithium containing solution.

Additionally, in some implementations, the process 322 of precipitating metals can incorporate calcium carbonate (CaCO₃) 338 from the calcium precipitation 334 discussed in further detail below. For example, the CaCO₃ 338 can act as a neutralizing agent in the process 322 of precipitating metals by reacting with some of the acid and raising the pH. In these or other embodiments, by incorporating the recycled CaCO₃ 338 the methods recycle what would otherwise be a waste stream.

As mentioned above, in some embodiments, processing the metals containing solution resulting from the acid leaching 310 also includes the MHP filtration/separation 326. For example, the methods can include the MHP filtration/separation 326 of the lithium containing solution resulting from the process 322 of precipitating metals. In some implementations, the MHP filtration/separation 326 filters the MHP 328 and the gypsum 330 from the lithium containing solution. As shown, in one or more embodiments, however, the MHP filtration/separation 326 separates the gypsum 330 from the MHP 328. Indeed, the methods include separating the gypsum 330 from the MHP 328 by exploiting the size differences between the metal precipitates and the gypsum 330. Furthermore, in some implementations, the MHP filtration/separation 326 utilizes a wash solution 332 which can displace a portion of the lithium in the solution phase. In these or other embodiments, the methods include recycling the wash solution 332 to the acid leaching 310 to recover the lithium and reuse what would otherwise be a waste stream.

As just mentioned, in one or more embodiments, MHP filtration/separation 326 separates the gypsum from the MHP 328 by exploiting the size differences. In these or other embodiments, the methods include growing gypsum crystals to a suitable size to allow separation of the gypsum 330 and base metals by controlling the process conditions (e.g., temperature, time, etc.) and recycling some of the gypsum 330 in the process. In some embodiments, some of the base metals may be entrained with the gypsum phase. In these or other embodiments, the methods can include removing these metals through an acid washing process performed using solid/liquid separation techniques, (e.g., centrifugation). In other embodiments, the methods can include directing the MHP 328 to other battery recycling processes or it can be sold separately.

As noted above, in one or more embodiments, the process 300 includes calcium precipitation 334 of the lithium containing solution resulting in the lithium sulfate solution 340. In some implementations, the calcium precipitation 334 is substantially similar to, and provides similar benefits as, the calcium precipitation 226 discussed above. For example, the calcium precipitation 334 can include providing CO₂ or soda ash 336 to the lithium containing solution and result in a CaCO₃ 338 byproduct, which the methods can recycle to the process 322 of precipitating metals. Also, similar to the calcium precipitation 226, the calcium precipitation 334 results in the lithium sulfate solution 340. In one or more embodiments, CO₂ results in no Na in the final product, which helps prevent losses of lithium due to managing the levels of sodium in the final product.

As stated above, in some implementations, the process 300 includes recovering lithium from the lithium sulfate solution 340 by a process 348 of converting the Li₂SO₄ to Li₂CO₃ 352 and/or LiOH 354. For example, in one or more embodiments, the process 348 of converting the Li₂SO₄ to Li₂CO₃ 352 and/or LiOH 354 is substantially similar to the process 240 of converting the Li₂SO₄ 240 above and therefore will not be further discussed. Moreover, in some embodiments, the Li₂SO₄ 346 is also generated from a process 342 of evaporating the lithium sulfate solution which is substantially similar to the process 234 of evaporating the lithium sulfate solution discussed above. Indeed, the process 342 of evaporating the lithium sulfate solution also generates water 344 which the methods can include recycling back into the battery recycling process.

As mentioned, in one or more embodiments, the process 300 includes recycling H₂SO₄ 350, a byproduct of the process 348 of converting the lithium sulfate, to the acid leaching 310. For example, the recycling of H₂SO₄ 242 can be similar to the recycling of H₂SO₄ 242 described above and thus will not be discussed further.

As mentioned above, one or more embodiments include recovering a nickel containing product in the form of MMS and lithium from battery manufacturing scrap materials. For example, FIG. 4 illustrates a process 400 for recovering an MMS from the metals containing stream resulting from the acid leaching 410 in accordance with one or more embodiments. Specifically, the process 400 can include processing manufacturing materials 402 via mechanical separation 404 resulting in a BM fraction 408 (or BM 408). In general, the process 400 includes processing manufacturing materials 402 from the manufacturing of lithium ion batteries to products that the methods can subsequently send back into a battery material supply chain. In some embodiments, implementation of the process 400 minimizes capital and operating cost, while also lowering the environmental impact by avoiding the formation of a sodium sulfate byproduct.

As mentioned, in some implementations, the process 400 includes processing the manufacturing materials 402 via the mechanical separation 404 resulting in the BM 408. The mechanical separation 402 can utilize size sorting, size reduction, or screening to separate various scrap materials. For example, the mechanical separation 402 can separate metals 406 (e.g., Al, Fe, Cu). As an example, the mechanical separation 402 can separate cathode active materials from aluminum foil held on with binder. Further, the mechanical separation 404 can separate graphite from copper foil, among other materials. Additionally, the methods optionally can include reincorporating the separated aluminum foil and copper foil back into other battery recycling processes. Moreover, the mechanical separation can isolate separator material and can incorporate the separator material (e.g., polyolefin, ceramics, polymer/ceramic blends) into other battery manufacturing processes. Alternatively, the separator material can be sold to third parties. In one or more embodiments, the mechanical separation 402 process can result in a black mass (BM) fraction 408 containing lithium and various metals, which the methods can utilize in additional processing steps. Indeed, the mechanical separation 404 can separate metals 406 (e.g., Al, Fe, Cu) and various other battery materials in a similar manner and for similar purposes as described above with respect to the mechanical separation 104. Also, in one or more embodiments, the mechanical separation 404 results in the BM 408 of similar composition/s to the BM 108 as described.

Further, in one or more implementations, the process 400 includes acid leaching 410 the BM 408 in a hydrometallurgical circuit. In particular, the acid leaching 410 process comprises a reductive acid leaching process that utilizes acid 414 (e.g., sulfuric acid (H₂SO₄)), peroxide 412, and water 416. In these or other embodiments, the methods include tailoring the conditions of the acid leaching 410 to be within the reductive portion of the ORP. Specifically, acid leaching 410 can operate with an ORP of between approximately 500 and approximately 800 and a pH of between approximately 1.0 and approximately 4.0. In some implementations, the methods also utilize the recycled H₂SO₄ 458 in the acid leaching 410 as discussed in further detail below.

In one embodiment, the acid leaching 410 liberates nearly all the metals into a metal solution. For example, the metal solution can comprise Ni, Co, Al, Li, and Cu as sulfates (e.g., a metal sulfates solution) and graphite. In some embodiments, the acid leaching 410 can liberate nearly all the lithium into solution. For example, the acid leaching can liberate more than 90%, more than 80%, more than 70%, more than 60%, or more than 50% of the lithium into solution. Further, in one or more implementations, the acid leaching 410 can liberate between 30 to 50%, between 20 to 60%, or between 10 to 98%. As shown, the process 400 further comprises an acid leach filtration 418 step that separates out the graphite 420.

As mentioned above, the process 400 includes processing the metals containing stream resulting from the acid leaching 410 and filtration 418 to recover MMS. For example, the methods include producing the MMS 422. Specifically, the process of producing the MMS 422 includes producing an MMS of nickel and cobalt sulfate, using an evaporator and/or crystallizer, from the filtrate containing metals. In these and other embodiments, the methods can recover approximately 80% of the Ni and Co with negligible lithium being recovered. In some embodiments, the process of producing the MMS 422 can recover more or less of the Ni and Co with negligible lithium being recovered. For example, the process of producing the MMS 422 can recover 75-85%, 70-90%, 60-95%, or 50-99% of the Ni and Co. In one or more implementations, the resulting mother liquor can comprise substantially all of the lithium and approximately 20% of the unrecovered Ni and Co. In some implementations, the resulting mother liquor can include less of the lithium and more of the Ni and Co. For example, in these or other embodiments, the resulting mother liquor can include 90-95% of the lithium, 80-90% of the lithium, 70-80% of the lithium, or 60-70% of the lithium. Additionally, in these or other embodiments, the resulting mother liquid can include 15-25%, 10-30%, 5-40%, or 1-50% of the Ni and Co.

Specifically, in one or more embodiments, the process 422 of producing the MMS includes evaporating and/or crystalizing the Ni and Co from a solution stream of Mn/Ni/Co/Li (e.g., the filtrate containing metals). In one or more implementations, the process of producing the MMS 422 can also include controlling the extent of the evaporation and/or crystallization such that no lithium is included in the MMS, leaving the lithium in a residual solution coming from the centrifuge (i.e., a centrate). The centrifuge separates the MMS solid crystal and the solution phase (e.g., the centrate). In one or more embodiments, the MMS contains about 70-80% of the Ni/Co and the centrate contains the residual Ni/Co and all of the lithium. In other embodiments, the MMS can contain about 60-90% or about 50-95% of the Ni/Co, with the centrate containing the residual Ni/Co in each case. Further, in some implementations, the residual can contain less of the lithium, for example, about 90-99%, about 80-95%, or about 70-90% of the lithium. In one or more embodiments, the MMS at this stage is not traditional battery grade, but can be sold as crude MMS, with the main impurities including Al, Cu, and Fe, among others.

As mentioned above, in some implementations, the methods include the process 424 of purifying the MMS and recycling the purified MMS 426 into pCAM processing 428. Optionally, in some embodiments, rather than integrate the removal of the MMS impurities in the process 400, which can cause complications of significant capital expenditure, the process involves moving purification of the MMS to an external circuit better suited to pCAM integration. Specifically, the use of sodium reagents in MMS purification and pCAM and presence of lithium can lead to complications in the separation of sodium and lithium. In these or other embodiments, after redissolving the MMS into solution in a separate process, the methods can include feeding the dissolved and purified MMS 426 as a solution into pCAM processing 428. In one or more embodiments, the process 424 of purifying the MMS includes oxidation and precipitation at elevated pH levels and the use of sulfides (e.g., sodium sulfide), caustic, and/or peroxide.

In one or more embodiments, the methods can include incorporating other purification techniques for the process 424 of purifying the MMS as can be understood by one skilled in the art. For example, the process 424 of purifying the MMS solution includes any one of various methods such as oxidation and precipitation at elevated pH, ion exchange or solvent extraction, or other purification techniques. The process 424 of purifying the MMS can purify the MMS such that the impurities levels of the contaminants are less than about 10 ppm, or less than about 7 ppm, or less than about 6 ppm, or less than about 5 ppm, or less than about 4 ppm, or less than about 3 ppm, or less than about 2 ppm, or less than about 1 ppm.

As mentioned above, in some implementations, after purifying the MMS solution to produce MMS that is a suitable feed to pCAM without further purification, the methods can further utilize the purified MMS 426 in pCAM processing 428. For example, process 428 includes mixing MMS solution with other metal sources to adjust the metal ratios in order to suit the desired pCAM product and also acts as a diluent for impurities.

As mentioned above, in some implementations, the process 400 includes a process 430 of precipitating deleterious elements, such as but not limited to, Fe, Al, and Cu from the centrate remaining after recovering the MMS. More specifically, the methods can include separating metals in the centrate from lithium. For example, the process 430 of precipitating the metals includes adding lime 432 (e.g., Ca(OH)₂) to the centrate to elevate the pH to levels from approximately 2.0 to approximately 5.0. In these embodiments, the elevated pH causes formation of an MHP 436 and gypsum 434. Further, this MHP 436 incorporates some metals in solution (e.g., Ni and Co) but not lithium. In one or more embodiments, the process 422 of producing the MMS can only evaporate so much of the MMS solution before beginning to incorporate the lithium. Accordingly, in some implementations, producing the MMS includes terminating evaporation before incorporating the lithium. Thus, in these or other embodiments, the centrate contains all of the lithium.

Further, in one or more embodiments, precipitating metals 430 optionally includes using limestone (CaCO₃) to get the solution to a pH of approximately 6.0 and then treating the feed solution with hydrated lime 432. Moreover, in some embodiments, the gypsum 434 contaminates the resulting MHP 436 rendering it low grade However, in these embodiments, the methods can include separating the gypsum 434 from the base metals precipitate by exploiting the size differences between the metal precipitates and the gypsum 434. For example, in these or other embodiments, the methods include growing gypsum crystals to a suitable size to allow separation of the gypsum 434 and metals by controlling the process conditions (e.g., temperature, time, etc.) and recycling some of the gypsum 434 in the process. In some embodiments, some of the base metals may be entrained with the gypsum phase. In these or other embodiments, the methods can include removing these metals through an acid washing process performed using solid/liquid separation techniques, (e.g., centrifugation). In other embodiments, the methods can include directing the MHP 436 to other battery recycling processes or it can be sold separately. Thus, the process 430 of precipitating the metals is low cost, simple, and allows for recovery of various base metals. Further, the process does not precipitate lithium and, therefore, the lithium can proceed through to subsequent lithium recovery processing.

In one or more embodiments, the process 430 of precipitating the metals can also precipitate the MHP 436 in a way to first remove Al allowing for the recycling of the resulting Ni and Co to the reductive acid leaching 410 and incorporation of the Ni and Co units into the MMS. This potentially introduces calcium into the MMS circuit but it can be managed by controlling the configuration of the MMS evaporator and then removal of calcium in the process 424 of purifying the MMS using IX or SX. In another embodiment, the methods can include using the MHP 436 as a precipitating agent for Al and Fe before the MMS evaporator. In this or other embodiments, the method includes controlling the calcium in the MMS evaporator and/or removal in the MMS purification circuit.

As mentioned previously, in one or more embodiments, the process 400 includes the calcium precipitation 438 of the lithium containing solution resulting from the process 430 of precipitating metals. For example, the calcium precipitation 438 can include continuously drawing the soda ash and/or carbon dioxide 440 to lower the calcium concentration in the solution. As mentioned above with respect to the calcium precipitation 226, this prevents fouling and contamination in subsequent processes as well as preventing negative impacts on product quality. In some embodiments, the calcium precipitation 438 results in CaCO₃ 442. In these or other embodiments, the methods include recycling the CaCO₃ 442 to the process 430 of precipitating the metals which results in similar benefits as described above with respect to the CaCO₃ 230 of FIG. 2. In some embodiments, in addition to providing lime, the process 430 of precipitating the metals can include concurrently providing the soda ash and/or carbon dioxide 440 to lower the calcium concentration. In these or other embodiments, the methods include providing the soda ash or carbon dioxide after precipitating the MHP 436 to avoid contact of the soda ash or carbon dioxide with the lime 432 or gypsum 434.

The foregoing embodiments of the process 430 of precipitating the metals from centrate avoid the formation of sodium sulfate, which is conventionally used in MHP 436 precipitation or impurity removal and must be dealt with as part of a recycling process. This may be particularly problematic in conventional processes when lithium is also present, as the lithium and the sodium must be separated, which translates to additional time, cost, and complexity. For example, conventional systems form sodium sulfate resulting in the need to separate the sodium sulfate and the Li₂SO₄.

As mentioned, in some embodiments, the methods can include recovering lithium as lithium sulfate salt by converting the Li₂SO₄ 450 to battery grade LiOH 456 and/or Li₂CO₃ 454. Similar to the recovery and conversion of lithium discussed above with respect to FIG. 2, this recovery and conversion also avoids the formation of sodium sulfate, which has the challenges discussed above.

In one or more embodiments, the processes 430 of precipitating the metals and calcium precipitation 438 result in a lithium sulfate solution 444. In some embodiments, the process 400 includes a process of evaporating the lithium sulfate solution 444, which results in water 448, which the methods can recycle back into the battery recycling process. The methods can hold the Li₂SO₄ 450 as a solution or a solid crystal for later redissolution. The process 400 can further include converting the Li₂SO₄ 450 by electrolysis.

As just mentioned, in one or more embodiments, the process 400 includes the process 452 of converting the lithium sulfate by electrolysis to Li₂CO₃ 454 (indirectly) or battery grade LiOH 456 (directly). Indeed, in some embodiments, the process 452 can be substantially similar to the process 240 of converting the lithium sulfate described above. Moreover, The electrolysis can also generate dilute acid (e.g., dilute H₂SO₄ 458) as a byproduct. Further, the process 400 can include maintaining a water balance such that the process 400 can include recirculating the H₂SO₄ 458 back into the battery recycling process (e.g., back to reductive acid leaching 410) or for use in other manufacturing processes. As a result, the system can offset some of the acid 414 input to the acid leaching 410 and significantly improve the economics and carbon dioxide footprint of the recycling process as well as regenerate caustic for the pCAM process.

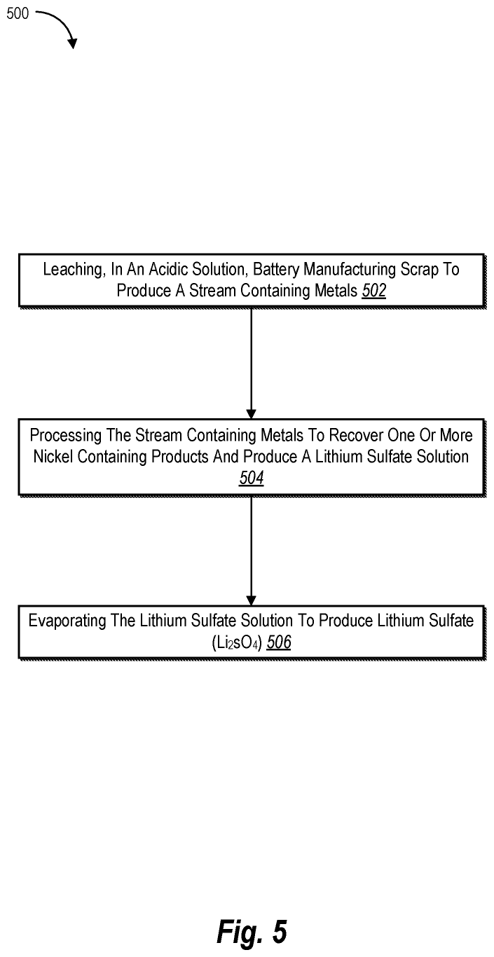

FIGS. 1-4, the corresponding text, and the examples provide a number of different systems and methods for recovering lithium and nickel containing products from battery manufacturing scrap materials with improved byproducts and minimal waste streams. In addition to the foregoing, embodiments can also be described in terms of flowcharts comprising acts for accomplishing a particular result. For example, FIGS. 5-7 illustrate flowcharts of example sequences of acts in accordance with one or more embodiments. While FIGS. 5-7 illustrate acts according to some embodiments, alternative embodiments may omit, add to, reorder, and/or modify any of the acts shown in FIGS. 5-7. Additionally, the acts described herein may be repeated or performed in parallel with one another or in parallel with different instances of the same or other similar acts.

FIG. 5 illustrates an example series of acts 500 for recovering lithium and nickel containing products from battery manufacturing scrap materials. The series of acts 500 can include an act 502 of leaching, in an acidic solution, battery manufacturing scrap materials to produce a stream containing metals (e.g., Ni, Co, and Li). The series of acts 500 can include an act 504 of processing the stream to recover one or more nickel containing products and produce a lithium sulfate solution. For example, act 504 can comprise processing the stream to recover one or more nickel containing products by processing the stream containing metals to recover a mixed metal sulfate (MMS) and produce a lithium containing centrate. Further, in one or more embodiments, act 504 can comprise purifying the MMS by oxidation and precipitation at elevated pH levels from 2.0 to 5.0. Additionally, act 504 can comprise providing the purified MMS as a feed to precursor cathode active material (pCAM) processing. Moreover, the act 504 can comprise precipitating, utilizing a calcium based product, one or more metals from the lithium containing centrate without producing sodium containing byproducts.

Furthermore, in one or more implementations, the act 504 can comprise processing the stream to recover one or more nickel containing products by processing a slurry to recover a hydro metal concentrate comprising a mixed hydroxide precipitate (MHP), gypsum, and a high nickel concentrate. Additionally, in one or more embodiments, processing the stream to recover the hydro metal concentrate comprises precipitating, utilizing a calcium based product, one or more metals from the stream to produce the MHP, the gypsum, and a lithium containing solution. Moreover, in some embodiments, act 504 can further comprise processing the stream to recover the hydro metal concentrate by filtering the MHP, the gypsum, and the high nickel concentrate from the lithium containing solution.

Additionally, in some implementations, act 504 can comprise processing the stream to recover one or more nickel containing products by processing the stream to recover a high nickel concentrate. Further, act 504 can comprise processing the stream to recover the high nickel concentrate by filtering, utilizing a filter aid, the high nickel concentrate from the stream. Moreover, act 504 can further comprise precipitating, utilizing a calcium based product, one or more metals from the stream to produce a mixed hydroxide precipitate (MHP), gypsum and a lithium containing solution. Further, act 504 can comprise removing, from the lithium containing solution, the MHP and the gypsum.

The series of acts 500 can include an act 506 of evaporating the lithium sulfate solution to produce lithium sulfate (Li₂SO₄). In one or more implementations, act 506 can further comprise converting the lithium sulfate (Li₂SO₄) to at least one of lithium hydroxide (LiOH) or lithium carbonate (Li₂CO₃) by electrolysis or other conventional methods of lithium recovery.

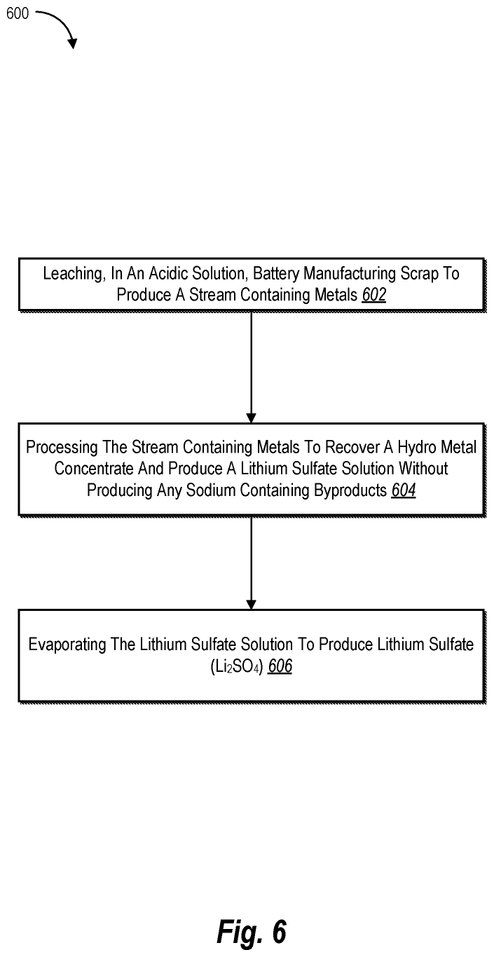

FIG. 6 illustrates an example series of acts for recovering lithium and a hydro metal concentrate from battery manufacturing scrap materials. The series of acts 600 can include an act 602 of leaching, in an acidic solution, battery manufacturing scrap materials to produce a stream containing metals (e.g., Ni, Co, and Li).

The series of acts 600 can include an act 604 of processing the stream to recover a hydro metal concentrate and produce a lithium sulfate solution without producing any sodium containing byproducts. Moreover, in some embodiments, the act 604 can further comprise precipitating, utilizing lime, metals from the solution containing metals to produce a mixed hydroxide precipitate (MHP), gypsum, and a lithium containing solution. Additionally, in one or more implementations, the act 604 can further comprise recovering, by filtration from the lithium containing solution, the hydro metal concentrate comprising a high nickel concentrate, the MHP, and the gypsum. Further, the act 604 can further comprise precipitating, using at least one of soda ash or carbon dioxide, calcium from the lithium containing solution. Furthermore, the series of acts 600 can include an act 606 of evaporating the lithium sulfate solution to produce lithium sulfate (Li2SO4).

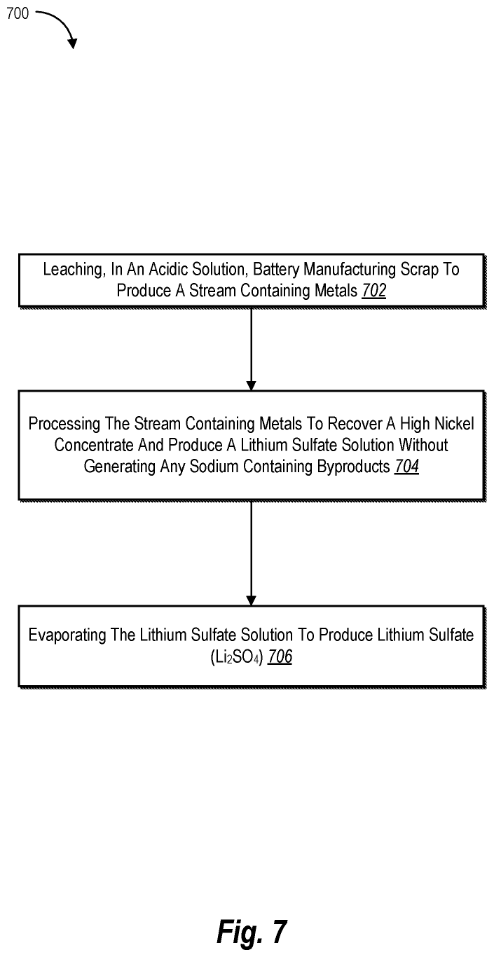

FIG. 7 illustrates an example series of acts 700 for recovering lithium and a high nickel concentrate from battery manufacturing scrap materials. The series of acts 700 can include an act 702 of leaching, in an acidic solution, battery manufacturing scrap materials to produce a stream containing metals (e.g., Ni, Co, and Li).

Additionally, the series of acts 700 can include an act 704 of processing the stream to recover a high nickel concentrate and produce a lithium sulfate solution without generating any sodium containing byproducts. For example, act 704 can involve processing the stream to recover the high nickel concentrate by filtering, from the solution, the high nickel concentrate utilizing a diatomaceous earth filter aid. Additionally, the series of acts 700 can include adding lime to precipitate one or more metals from the stream to produce a mixed hydroxide precipitate (MHP), gypsum, and a lithium containing solution.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
leaching, in an acidic solution, battery manufacturing scrap materials to produce a stream comprising nickel (Ni), cobalt (Co), and lithium (Li);
processing the stream to recover one or more nickel containing products and produce a lithium sulfate solution; and
evaporating the lithium sulfate solution to produce lithium sulfate (Li₂SO₄).

2. The method of claim 1, wherein processing the stream to recover one or more nickel containing products comprises processing the stream to recover a mixed metal sulfate (MMS) and produce a lithium containing centrate.

3. The method of claim 2, further comprising purifying the MMS by oxidation and precipitation of deleterious elements such as, but not limited to, Fe, Al and Cu at elevated pH levels from 2.0 to 5.0.

4. The method of claim 3, further comprising providing the purified MMS as a feed to precursor cathode active material (pCAM) processing.

5. The method of claim 2, further comprising precipitating, utilizing a calcium based product, one or more metals from the lithium containing centrate without producing sodium containing byproducts.

6. The method of claim 1, wherein processing the stream to recover one or more nickel containing products comprises processing a slurry to recover a hydro metal concentrate comprising a mixed hydroxide precipitate (MHP), gypsum, and a high nickel concentrate.

7. The method of claim 6, wherein processing the stream to recover the hydro metal concentrate comprises precipitating, utilizing a calcium based product, one or more metals from the stream to produce the MHP, the gypsum, and a lithium containing solution.

8. The method of claim 7, wherein processing the stream to recover the hydro metal concentrate further comprises filtering the MHP, the gypsum, and the high nickel concentrate from the lithium containing solution.

9. The method of claim 1, wherein processing the stream to recover one or more nickel containing products comprises processing the stream to recover a high nickel concentrate.

10. The method of claim 9, wherein processing the stream to recover the high nickel concentrate comprises filtering, utilizing a filter aid, the high nickel concentrate from the stream.

11. The method of claim 10, further comprising precipitating, utilizing a calcium based product, one or more metals from the filtered stream to produce a mixed hydroxide precipitate (MHP), gypsum and a lithium containing solution.

12. The method of claim 11, further comprising removing, from the lithium containing solution, the MHP and the gypsum.

13. The method of claim 1, further comprising converting the lithium sulfate (Li₂SO₄) to at least one of lithium hydroxide (LiOH) or lithium carbonate (Li₂CO₃) by electrolysis.

14. A method comprising:
leaching, in an acidic solution, battery manufacturing scrap materials to produce a stream comprising nickel (Ni), cobalt (Co), and lithium (Li);
processing the stream to recover a hydro metal concentrate and produce a lithium sulfate solution without producing sodium containing byproducts; and
evaporating the lithium sulfate solution to produce lithium sulfate (Li₂SO₄).

15. The method of claim 14, further comprising precipitating, utilizing lime, one or more metals from the stream to produce a mixed hydroxide precipitate (MHP), gypsum, and a lithium containing solution.

16. The method of claim 15, further comprising recovering, by filtration from the lithium containing solution, the hydro metal concentrate comprising a high nickel concentrate, the MHP, and the gypsum.

17. The method of claim 16, further comprising precipitating, using at least one of soda ash or carbon dioxide, calcium from the lithium containing solution to produce the lithium sulfate solution.

18. A method comprising:
leaching, in an acidic solution, battery manufacturing scrap materials to produce a stream comprising nickel (Ni), cobalt (Co), and lithium (Li);
processing the stream containing metals to recover a high nickel concentrate by filtering and produce a lithium sulfate solution without generating any sodium containing byproducts; and
evaporating the lithium sulfate solution to produce lithium sulfate (Li₂SO₄).

19. The method of claim 18, wherein processing the stream containing metals to recover the high nickel concentrate comprises filtering, from a slurry containing metals, the high nickel concentrate utilizing a diatomaceous earth filter aid.

20. The method of claim 19, further comprising adding lime to precipitate one or more metals from the stream containing metals to produce a mixed hydroxide precipitate (MHP), gypsum, and a lithium containing solution.
